(19) United States
(12) Patent Application Publication
(10) Pub. No.: US 2019/0094836 A1
(43) Pub. Date: Mar. 28, 2019

(54) INTERIOR DESIGN PRODUCT FABRICATING SYSTEM USING 3D PRINTER, AND METHOD THEREFOR

(71) Applicant: Sang Hun PARK, Mungyeong-si, Gyeongbuk (KR)

(72) Inventor: Sang Hun PARK, Mungyeong-si, Gyeongbuk (KR)

(21) Appl. No.: 16/092,181

(22) PCT Filed: Apr. 19, 2017
(86) PCT No.: PCT/KR2017/004181

§ 371 Date: Oct. 8, 2018

(30) Foreign Application Priority Data
Apr. 27, 2016 (KR) 10-2016-0051572

(51) Int. Cl. G05B 19/4099; B33Y 50/00; B33Y 40/00

(52) U.S. Cl. CPC G05B 19/4099; B33Y 50/00; G05B 2219/49007; G05B 2219/35134; B33Y 40/00

(57) ABSTRACT

The present invention relates to a system for fabricating an interior design product by using a 3D printer, and a method thereof, the system and method being capable of enabling a user to select a design when the user access the interior design server and selects a specific interior design product, and delivering the interior design product of the selected design by fabricating the same by using a 3D printer. In addition, according to the present invention, the system includes: an interior design server providing a list of interior design products, providing a simulation enabling a user to place the selected product in a virtual space, and generating and outputting 3D printing information of the interior design product having the corresponding design; and a 3D product output center receiving the 3D printing information generated in the interior design server and fabricating the interior design product by using a 3D printer.

### TECHNICAL FIELD

The present invention relates to a system for fabricating an interior design product, and a method thereof. More particularly, the present invention relates to a system for fabricating an interior design product by using a 3D printer, and a method thereof, the system and method being capable of enabling a user to select a design by providing a simulation when the user access the interior design server and selects a specific interior design product, and delivering the interior design product of the selected design by fabricating the same by using a 3D printer.

### BACKGROUND

Recently, the use of Internet communication networks and computers has spread rapidly, and the field using computers has been rapidly expanding beyond enterprise computerization work to all industrial fields.

The above trend has led to develop of a means for generating online a virtual space in association with a real space and performing interior design for the same by placing various fixtures and furniture within a limited space. The representative example of the above case may be an e-model house.

However, the conventional e-model house merely shows a video where the entire predetermined area is uniformly divided into areas having a predetermined area such as room, living room, kitchen, bathroom, etc. and displays a layout of furniture necessary for real life of the resident. However, a method of variably dividing a space according to the provided conditions is not provided.

For example, in a case where a fixed space is divided into a plurality of spaces such as office, private education institute, business counseling office, etc., a main design goal is to satisfy various conditions such as a movement path of users using the space, intensity of illumination of lights, etc. When such a method is developed, variable spatial division may be effectively performed.

For the same, as a conventional method, Korean Patent No. 10-1492375 discloses a method of dividing a virtual space by using a partition wall wherein a large virtual space provided is divided into a plurality of spaces by using a partition wall so as to satisfy various conditions, and a series of processes of applying the same in a real space is provided online.

The above conventional method divides the virtual space into a plurality of spaces by using various forms of partition walls

in consideration of given conditions, and by applying the same to an offline real space enables construction of the most suitable and satisfactory space division configuration according to a customer's requirement.

Meanwhile, recently, a method of fabricating various products using a 3D printer has received a great deal of attention. In addition, when the 3D printing method is added to the conventional spatial division method, satisfying user need while saving time and money are possible.

### DISCLOSURE

### Technical Problem

In order to meet the above needs, the present invention is to provide a system for fabricating an interior design product by using a 3D printer, and a method thereof, the system and method being capable of enabling a user to select a design by providing a simulation when the user access an interior design server and selects a specific interior design product and fabricating the interior design product of the selected design and delivering the same.

### Technical Solution

According to an aspect of the present invention, the present invention includes: an interior design server providing a list of interior design products to a user terminal accessed thereto, when the user selects a specific interior design product, providing a simulation enabling a user to place the selected interior design product in a virtual space, and when the user selects the interior design product having a desired design and requests an order for the same, generating and outputting 3D printing information of the interior design product having the corresponding design; and a 3D product output center receiving the 3D printing information generated in the interior design server and fabricating the interior design product by using a 3D printer

In addition, when user selects an interior design product by using the user terminal, the interior design server according to one aspect of the present invention receives from the user terminal real space information, and generates and provides a virtual space in association with the received real space information, when various types of information is received from the user terminal, the when user selects a specific interior design product enables the user to perform designing a layout in the virtual space in association with the received information, and enables the user to select a desired form and color by providing various forms and colors for the selected interior design product.

In addition, the present invention further includes a delivery center performing delivery to the user according to a delivery request, and uploading a delivery state to a delivery server so that the user identifies the delivery state, and wherein when the fabrication of the interior design product is completed, the 3D product output center transmits the delivery request to the delivery center.

In addition, the 3D printing information includes 3D image information of the partition wall, thickness information of the partition wall, internal structure information of the partition wall, and material information of the partition wall.

In addition, the interior design server according to one aspect of the present invention includes: an interface performing communication with the user terminal through a network; an input unit for receiving various selection signals from the user; a product providing unit providing the list of the interior design products to the user terminal, and enabling the user to select the interior design product by using the user terminal; a simulation providing unit requesting and receiving information required for generating the virtual space in which the real space is reflected from the user through the user terminal, providing the simulation enabling the user to place the selected interior design product by providing the virtual space in which the real space is reflected in association with the received information, and enabling the user to finally select the desired products by selecting a desired form and color through the simulation; a data transform unit generating 3D image information including the thickness information, the internal structure information, and the material information such that the interior design products according to the order are fabricated by using the 3D printer; and a transmitting unit transmitting the 3D printing information to the 3D product output center

Meanwhile, according to another aspect of the present invention, the present invention includes: step (A) of providing, by an interior design server, a list of interior design products to a user terminal accessed thereto and when a specific interior design product is selected, providing a simulation enabling a user to place the selected interior design product in a virtual space; step (B) of generating, by the interior design server, 3D printing information of the interior design product having a corresponding design when the user select the interior design product having a desired design and places an order thereof, and transmitting the same to the 3D product output center; and step (C) of receiving, by the 3D product output center, the 3D printing information generated in the interior design server, and fabricating the interior design product by using a 3D printer.

In addition, according to another aspect of the present invention, the present invention may further include: step (D) of transmitting, by the 3D product output center, a delivery request to a delivery center when fabrication of the interior design product is completed; and step (E) of performing delivery, by the delivery center, to the user according to the delivery request, and uploading a delivery state to a delivery server such that the user identifies the delivery state

In addition, according to another aspect of the present invention, the 3D printing information includes 3D image information of the partition wall, thickness information of the partition wall, internal structure information of the partition wall, and material information of the partition wall.

In addition, according to another aspect of the present invention, the step (A) includes: step (A-1) of accessing, by the user, the interior design server through the user terminal; step (A-2) of providing, by the interior design server, the list of the interior design product to the user terminal; step (A-3) of selecting, by the user, the desired product from the provided list of the interior design products by using the user terminal; and step (A-4) of providing, by the interior design server, the simulation enabling the user to place the selected interior design product by providing the virtual space in which a real space is reflected

In addition, according to another aspect of the present invention, the step (A-4) includes: when the selected interior design product is a partition wall, transmitting, by the user terminal, real space information including a building name, an address, an area, horizontal and vertical lengths, a number of current lights, an intensity of illumination, an installation position to the interior design server; generating, by the interior design server, the virtual space in association with the real space information received from the user terminal; transmitting, by the user terminal, information required for dividing the generated virtual space into a plurality of spaces which includes a partition wall form, a size, whether or not to install a door, a number of persons to be accommodated in the virtual space, a number of rooms, a required intensity of illumination, and a movement path to the interior design server; generating, by the interior design server, a floor plan for dividing the virtual space into the plurality of spaces in association with the received information; selecting, by the interior design server, the partition wall for dividing the virtual space into the plurality of spaces according to the generated floor plan based on partition wall information transmitted from the user terminal; and dividing, by the interior design server, the virtual space into the plurality of spaces by using the selected partition wall, and displaying the same in a 3D manner.

### Advantageous Effects

Recently, a method of fabricating various products using a 3D printer has received a great deal of attention, since satisfying user need and saving time and money is possible by use of the 3D printer.

### BRIEF DESCRIPTION OF THE DRAWINGS

FIG. 1 is a view of a configuration showing a system for fabricating an interior design product by using a 3D printer according to the present invention.

FIG. 2 is a view of a flowchart showing a method of fabricating an interior design product by using a 3D printer according to the present invention.

FIG. 3 is a view of a configuration showing an interior design server of FIG. 1.

FIG. 4 is a view of a flowchart of method of fabricating an interior design product by using a 3D printer, the interior design product being a partition wall.

FIG. 5 is a view of an example showing a virtual space where a virtual space is divided by using a partition wall according to the present invention.

FIG. 6 is a plan view of a virtual space where a virtual space is divided by using a partition wall according to the present invention.

FIG. 7 is a view showing various examples of a partition wall used for dividing a virtual space wall according to the present invention.

FIG. 8 is a view of an example where a virtual space is divided by using a partition wall according to the present invention.

FIG. 9 is a view of an example where a virtual space is divided by using a partition wall of FIG. 7.

FIGS. 10 to 12 are views of an example showing a three-dimensional image of a virtual space for performing division of a space by using a partition wall according to the present invention.

FIG. 13 is a view of an example of assembling a partition wall, and FIG. 14 is a deployed view thereof.

### BEST MODE

Hereinafter, preferred embodiments of the present invention will be described with reference to the accompanying drawings.

The terms used in this specification are those general terms currently widely used in the art, but the terms may vary according to the intention of those of ordinary skill in the art, precedents, or new technology in the art.

Also, specified terms may be selected by the applicant, and in this case, the detailed meaning thereof will be described in the detailed description. Thus, the terms used in the specification should be understood not as simple names but based on the meaning of the terms and the overall description.

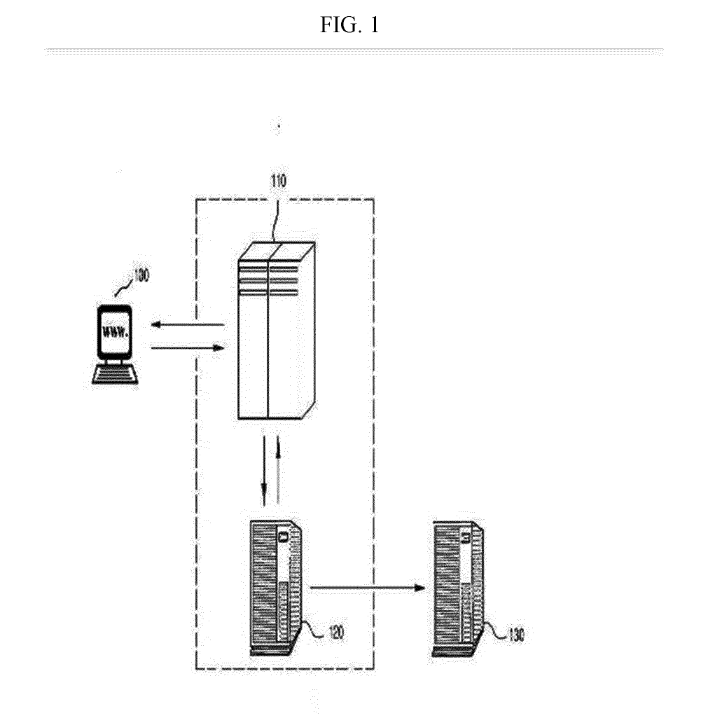

FIG. 1 is a view of a configuration showing a system for fabricating an interior design product by using a 3D printer according to the present invention.

Referring to FIG. 1, a system for fabricating an interior design product by using a 3D printer according to the present invention includes a user terminal 100, an interior design server 110, a 3D product output center 120, and a delivery center 130.

Herein, the user terminal 100 is a terminal performing communication with the interior design server 110 through a network, and may be a personal PC that is generally used. In addition to the personal PC, various devices such as a smartphone, a tablet PC, a laptop, etc. capable of performing communication with the interior design server 110 through a wired network or wireless network may be used as the user terminal 100.

The user is provided with a 2D or 3D image design of various interior design products provided from the interior design server 110 by accessing the interior design server 110 by using the user terminal 100. Herein, the provided various interior design products may include a desk, a chair, a sofa, a table, a book case, a cabinet, a partition wall, etc. However, the above items are only illustrative examples and may include various other products.

Subsequently, when the user selects a desired product among the provided interior design products by using the user terminal 100, the interior design server 110 provides a simulation enabling the user to place the selected product in a virtual space in which a real space is reflected. By using the above simulation, the user may finally select a product of a desired design by selecting his or her favorite form and color.

When a final selection is completed as above, the user makes online payment of the interior product having a design selected by using the user terminal 100, and requests the fabrication using the 3D printer and installation thereof. A fabricating process afterward is provided through the interior design server 110, or by accessing the 3D product output center 120. In addition, a delivery process is provided by accessing the delivery center 130.

Then, the interior design server 110 provides the interior design products in a 2D or 3D image when the user terminal 100 access thereto.

Subsequently, when the user 110 selects desired interior design products among them, the interior design server receives real space information, and provides a virtual space in association with the real space to the user terminal 100. When various types of information are received from the user terminal 100, designing is performed such that the best effective layout structure is deduced in the virtual space in accordance with the information, and various forms and colors for the selected interior design product are provided so that the user may select a desired form and color.

In addition, when a fabrication order using a 3D printer for the interior design product is received from the user terminal 100, the interior design server 110 generates 3D image information, thickness information, internal structure information, and material information, and transmits the same to the 3D product output center 120 so that the interior design products according to the order are fabricated by using the 3D printer.

Subsequently, in the 3D product output center 120, the interior design products are fabricated by receiving 3D image information, thickness information, internal structure information, and material information from the interior design server 110 and by using the 3D printer, and a delivery request thereof is transmitted to the delivery center 130.

Subsequently, the delivery center 130 performs delivery of the fabricated interior design products to the user according to the delivery request thereof, and provides a delivery state by uploading the same to a delivery server so that the user is able to identify the delivery state.

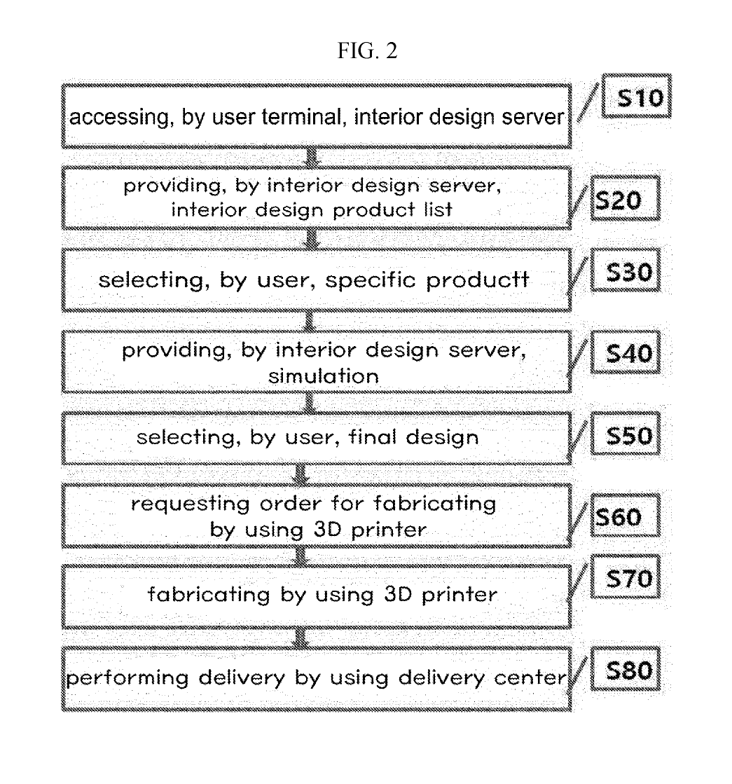

Meanwhile, a method of fabricating an interior design product by using a 3D printer according to the present invention is shown in FIG. 2.

First, in step S10, the user may access the interior design server 110 by using the user terminal 100, and in S20, the interior design server 110 may provide a list of various interior design products to the user terminal 100 in a 2D or 3D image.

Herein, various interior design products include a desk, a chair, a sofa, a table, a book case, a cabinet, a partition wall, etc.

When the interior design server 110 provides various interior design products as above, in S30, the user selects a desired product from the provided interior design product list by using the user terminal 100.

Subsequently, in S40, the interior design server 110 provides a simulation enabling the user to place the selected interior design products by providing a virtual space in which a real space is reflected, and in S50, the user may place the selected interior design products on the simulation provided through the user terminal 100 and finally selects a product having a desired design by placing and selecting a desired form and color.

The above case will be described in below by using a partition wall as the interior design product.

The interior design server 110 generates a virtual space in association with a real space. In order to divide the virtual space, the interior design server 110 receives information for generating the virtual space in association with the real space (building name, address, area, width and height lengths, number of current lights, intensity of illumination, position, etc.), and information required for dividing the virtual space into a plurality of spaces (partition wall form, size, whether or not to install a door, number of persons to be accommodated in the virtual space, number of rooms, intensity of illumination, movement path, etc.) through the user terminal 100 by transmitting a request for the same to the user.

Subsequently, the interior design server 110 generates the virtual space in association with the real space on the basis of information received from the user terminal 100, divides the generated virtual space into the plurality of spaces, and places partition walls so that the plurality of spaces is implemented in the real space, and enables the user to select a form and color for the placed partition walls so as to select a final design.

Meanwhile, when the user selects the final design and generates an order request for a production of the interior design product using a 3D printer through the user terminal 100, in S60, the interior design server 110 generates 3D image information, internal structure information, and material information for the interior design product, and transmits the same to the 3D product output center 120.

Herein, the user orders fabrication and installation of the interior products having the selected design by using the 3D printer by making online payment for the same.

In S70, the 3D product output center 110 fabricates the partition walls by receiving 3D image information, thickness information, internal structure information, and material information of the design products from the interior design server 120 and by using the 3D printer. In addition, a delivery request thereof is transmitted to the delivery center 130.

Subsequently, in S80, the delivery center 130 performs delivery of the products to the user according to the delivery request, and uploads a delivery state to a delivery server so that the user is able to identify the delivery state.

Then, the user is provided with, by using the user terminal 100, the fabrication process from the interior design server 110 or by accessing the 3D product output center 120, and provided with the delivery process by accessing the delivery center 130.

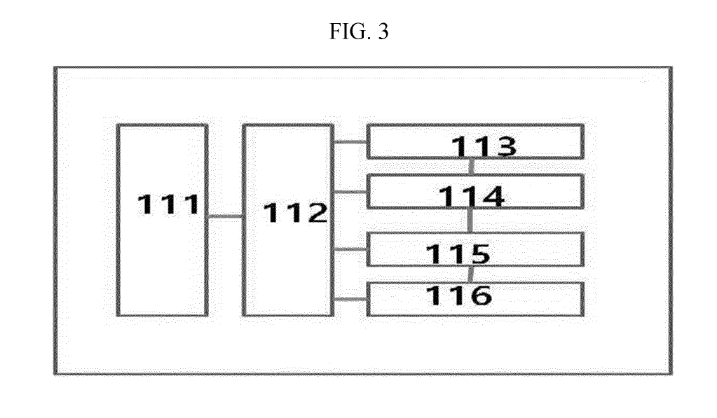

In order to perform the above functions, as shown in FIG. 3, the interior design server 110 is configured with: an interface 111 performing communication with the user terminal 100 through a network; an input unit for receiving various selection signals from the user; a product providing unit 113 providing interior design products in a 2D or 3D image to the user terminal 100, and enabling the user to select the interior design product by using the user terminal 100; a simulation providing unit 114 transmitting a request for information required for generating a virtual space in which a real space is reflected to the user through the user terminal 100, providing the virtual space in which the real space is reflected by receiving the information and applying the same, providing a simulation through which the selected interior design products are placed, and enabling the user to select a desired form and color by using the above simulation so as to finally select a desired design; a data transform unit 115 generating 3D printing information including 3D image information, thickness information, internal structure information, and material information so that the interior design products according to the order are fabricated by using a 3D printer; and a transmitting unit 116 transmitting the 3D printing information to the 3D product output center 110.

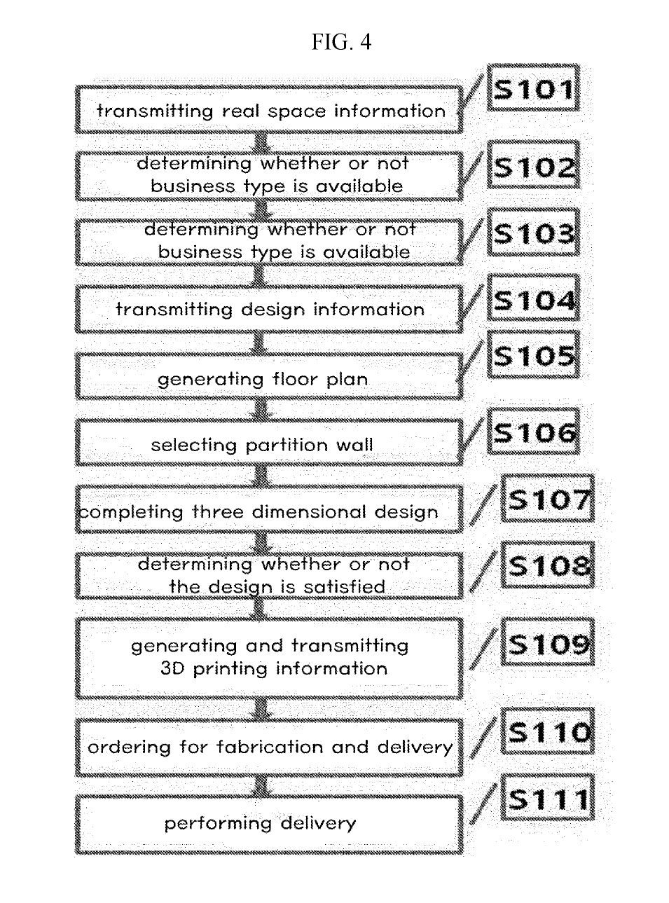

Meanwhile, in the interior design product fabricating method using the 3D printer according to the present invention, when a partition wall is selected by a user, the method includes, as shown in FIG. 4: S101 of transmitting real space information (building name, address, area, width and height lengths, number of current lights, intensity of illumination, position, etc.) from the user terminal 100 to the interior design server 110; S102 of determining whether the real space is a place where a business type that is desired by the user is available on the basis of the building name and address of the transmitted information; S103 of generating a corresponding virtual space on the basis of the received real space information when the real space is determined to be a place where the desired business type is available in S102; S104 of receiving information (partition wall form, size, whether or not to install door, number of persons to be accommodated in the virtual space, number of rooms, intensity of illumination, movement path, etc.) required for dividing the virtual space generated in S103 into a plurality of spaces; S105 of generating a floor plan for dividing the virtual space into the plurality of spaces in association with information received in S101 and information received in S104; S106 of selecting a partition wall for dividing the virtual space into the plurality of spaces according to the floor plan generated in S105; S107 of completing an interior design where the virtual space is divided into the plurality of spaces and showing the same in a three-dimensional manner by applying the partition wall selected in S106; S108 of verifying whether or not the interior design of the virtual space completed in S104 is satisfied; S109 of transforming the partition wall to be placed in the real space to 3D printing information according to the result of S108, and transmitting the same to the 3D product output center 120; S110 of fabricating partition walls by using the 3D printer in the 3D product output center 120, and transmitting a delivery request to the delivery center 130; and S111 of delivering, by the delivery center 130, to the user the fabricated partition walls according to the delivery request, and uploading a delivery state to a delivery server so that the user is able to identify the delivery state.

S101, S103 to S108 are steps performed by communication between the user terminal 100 and the interior design server 110 through a network, S102 is a step performed by network communication between the interior design server 110 and an available business type checking site, for example, between sites in association with the education office and the district office when the business type is to run an education business, S109 is a step performed by network communication between the interior design server 110 and the 3D product output center 120 according to a request of the user terminal 100, S110 is a step performed between the 3D product output center 120 and the delivery center 130, and S111 is a step performed between the delivery center 130 and the user or user terminal.

Hereinafter, the overall operation of the present invention will be described in more detail by dividing or integrating the same into or in stages.

1. Generating Virtual Space

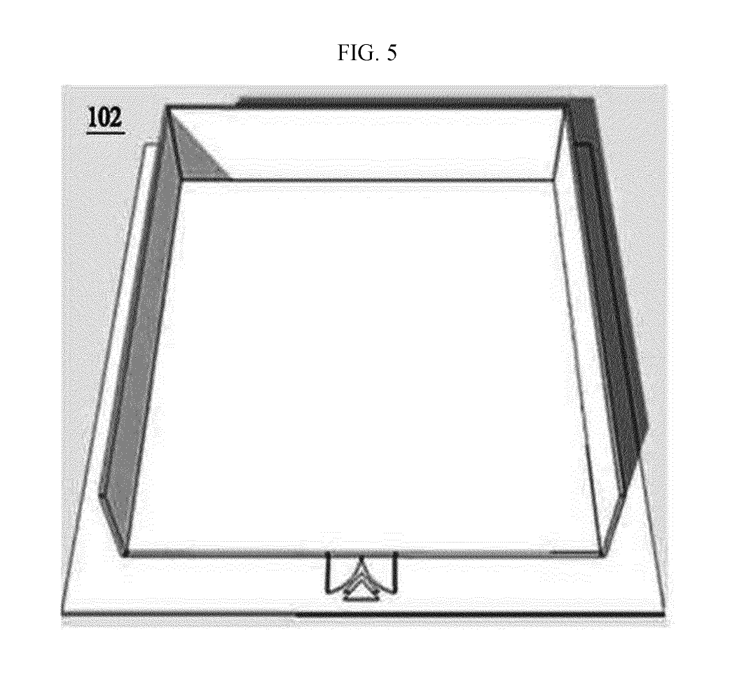

Under a state where the user terminal 100 and the interior design server 110 are connected through a network, when information of a real space is transmitted from the user terminal 100 to the interior design server 110, the interior design server 110 generates a virtual space 102 in association with the real space on the basis of the received information as shown in FIG. 5.

The real space refers to an internal space where the user wants to perform interior design. The virtual space is a space generated online by the interior design server 110, and is a space where the real space is minimized in size, area, and form by a predetermined ratio.

Accordingly, sizes of partition walls and other components which will be placed on the virtual space are downsized by the same ratio of the virtual space and displayed online.

Information of the real space for generating the virtual space 102 may include horizontal and vertical lengths, a ceiling length, interior design construction budget, etc.

In other words, the user may consider what kind of interior design form is required for the real space, and store and manages a list for desired interior design construction, information of interior design construction estimation budget, etc. in the interior design server 110. Herein, when the user wants to perform interior design of a study room of a private education institute, whether or not authentication or improvement of the corresponding building as a private education institute is available has to be checked, and such type of information is provided from a server in association with the education office which is linked to the interior design server 110.

The interior design server 110 generates the virtual space 102 as shown in FIG. 5, and transmits the same to the user terminal 100 so as to be stored and managed.

Meanwhile, when the real space is not a rectangle, the interior design server 110 enables the user to select a form of the virtual space that corresponds to the real space.

2. Generating Floor Plan

The real space may be a space where various types of businesses run. In other words, the real space may be a general office, a shop displaying merchandise, a café for drinking beverages, and a private education institute providing a learning space. The present invention will be described by finding application in a private education institute.

A person who wants to run a private education institute searches a building suitable for the institute and measures the dimensions of a real space (horizontal and vertical lengths, ceiling height, etc.), and transmits the same to the interior design server 110 by using the user terminal 100. Accordingly, the interior design server 110 checks whether or not the corresponding building is available for running a private education institute by using a linked site on the basis of information (building address, building name, etc.) received from the user terminal 100.

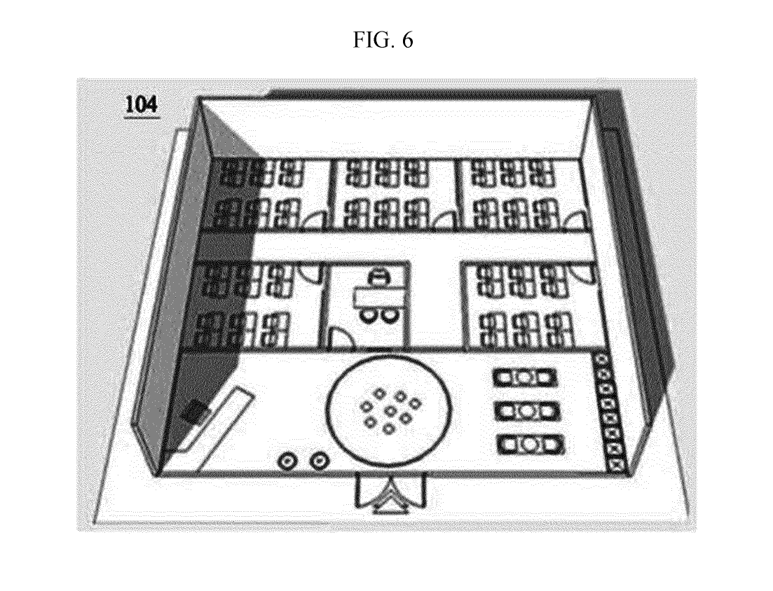

When running a private education institute is permissible, the interior design server 110 generates a floor plan 104 as shown in FIG. 6 for generating a suitable layout on the basis of various types of information (lights, windows, entrance, information desk, partition walls, number of persons to be accommodated in the virtual space, number of rooms, etc.) received from the user terminal 100.

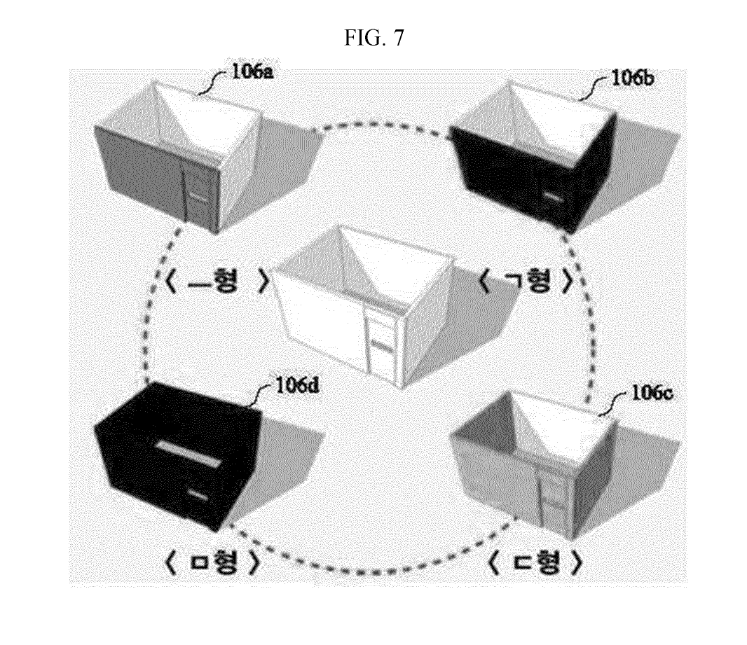

Herein, generating the floor plan 104 is performed on the basis of various forms of partition walls as shown in FIG. 7, the partition walls may be or may not be configured with a door. Selecting a partition wall with a door or without a door may be determined by referencing an area (size) of the virtual space, a number of persons to be accommodated therein and a number of rooms, a desk layout, a movement path, etc.

In addition, depending on a number of lights installed in the ceiling or wall and positions thereof, it is ensured that no dark spots occur by being out of illumination range of the lights. For example, when a floor plan is generated such that an arbitrary light is positioned between partition walls forming spaces different from each other, problem occurs in that intensity of illumination of the light emitting light to a space sub-divided by the partition wall becomes low, thus causing discomfort to learners while intensity of illumination between partition walls becomes unnecessarily high. Designing is performed to prevent such a problem. However, natural light that is reflected in the room from a window of a space where the window is open functions as a light having a certain intensity of illumination, and thus, according to the same, it is preferable to design such that light with uniform intensity of illumination is provided to spaces divided by partition walls. Herein, since intensity of illumination of natural light varies depending on the weather, such as sunny, cloudy, rainy, it is preferable to design in consideration of all of the same. However, designing may be performed by simply considering the position and size of the window.

In addition, rather than referencing a position and a number of lights of the real space transmitted from the user terminal 100 to the interior design server 110, the present invention performs dividing into a plurality of spaces by using partition walls, and additionally transmits information of a position and a number of lights in accordance of the plurality of spaces to the user terminal 100 so that the user may change and install a number and a position of lights on the basis of the above information when performing real space interior designing.

In addition, generating a floor plan of the present invention is performed in consideration of a number of desks placed in each space (in association with a number of persons to be accommodated), a position of a desk of a teacher who will give lesson in that space, and a movement path of students. For example, assuming that 12 desks are arranged in two columns where partition walls are installed, the best suitable movement path is generated by considering whether or not a movement path of students of the left column desks to be a path between the right column desks or to be a path between a left sided partition wall. Further consideration may include an open and closing structure of the window (sliding type or hinged type), determining an interval (width) of the movement path, determining a position of a door to be installed of the space subdivided by the partition wall, etc. For example, it is preferable to design the width of the movement path between spaces to be 1 meter, to design a width of a door to vary when the doors of the spaces are formed to face from each other so that collision between the doors are prevented when the doors are open at the same time, and to design the positions of the doors of the spaces to alternate so that the doors are not opened at the same positions.

In addition, designing is performed such that the best effective movement path between spaces subdivided by the partition wall is ensured, that is a movement path distance when leaving the spaces and going outside of the real space through the main door is ensured.

As described above, the interior design server 110 generates the floor plan 104 as shown in FIG. 6 by dividing the same into a classroom, a corridor, and an information desk, etc. in consideration of all of the above factors.

The user may verify the floor plan 104 provided from the interior design server 110, and variably change a position, a size, and a form of the classroom, the corridor, and the information desk.

A virtual space design as described above may represent a size at which partition walls are installed so as to be applied to the real space, and represent in a size, a form, and a position of a lecture desk and student desks which are placed within the space subdivided by the partition wall.

3. Selecting Partition Wall

When information of partition walls that will be placed in the floor plan is received in the interior design server 110 from the user terminal 100, the interior design server 110 places the partition walls in a virtual space according to the received information.

In other words, as shown in FIG. 6, when a floor plan is generated, the interior design server 110 selects a suitable partition wall among various types of partition walls 106a to 106d as shown in FIG. 7.

As shown in FIG. 7, the partition wall may be formed in at least one of a “— type” partition wall 106a formed with a front surface including a door, a “ [symbol] type” partition wall 106b formed with a front surface and a first lateral surface in connection to the front surface, a “H type” partition wall 106c formed with a front surface and first and second lateral surfaces in connection to the front surface, and a “□ type” partition wall 106d formed with a front surface, first and second lateral surfaces in connection to the front surface, and a rear surface facing the front surface. In addition, provision of the partition wall in various forms is available according to a form of the classroom and the corridor.

4. Design Completion

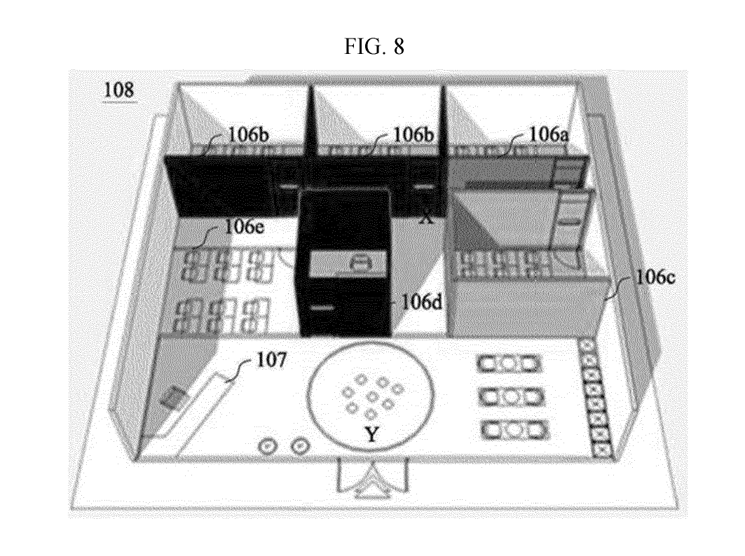

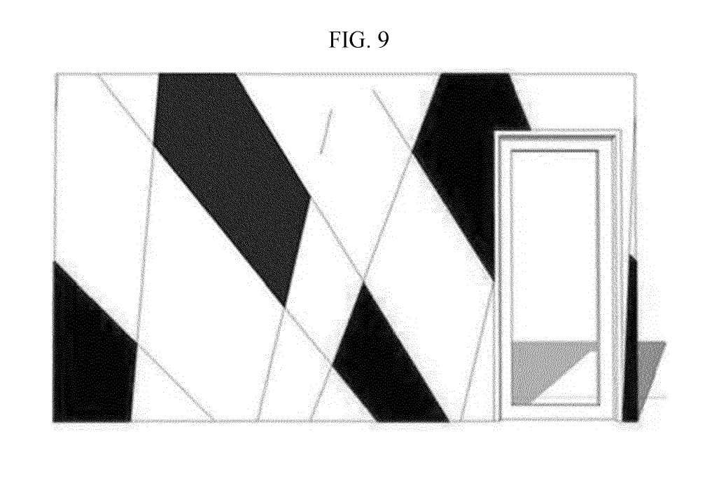

The interior design server 110 provides a virtual space design 108 where partition walls 106a to 106d are placed in a virtual space 102 as shown in FIG. 8 by using the generated floor plan and the partition wall information transmitted from the user terminal 100. In FIG. 8, an example of an interior space design 108 is shown which is configured with one “— type” partition wall 106a, two “ [symbol] type” partition walls 106b, one “Π type” partition wall 106c, one “□ type” partition wall 106d, and one information desk 107.

The partition walls may be classified into various types according to a form thereof as described above, but may be classified into various types according to a position of a door. In other words, the “Π type” partition wall 106c, in FIG. 7, a door is formed in a surface corresponding to a front surface, but in FIG. 8, a door is formed in a surface corresponding to a lateral surface. Accordingly, the user has to transmit information of the door to the interior design server 110 in addition to the form of the partition wall. However, as shown in FIGS. 5 to 8, the interior design server 110 provides various images, and thus the user may correct an error by directly checking the images, and the virtual space design 108 may be finally generated as shown in FIG. 8.

Meanwhile, in FIG. 8, in addition to the partition wall types shown in FIG. 7, a partition wall of a form 106e formed with a front surface and a rear surface has to be used. In other word, as described above, forms of the partition wall may be variably fabricated in various forms in addition to the forms shown in FIG. 7. In FIG. 8, a “∥ type” partition wall 106e formed with front and rear surfaces has to be placed to the left of the “□ type” partition wall 106d.

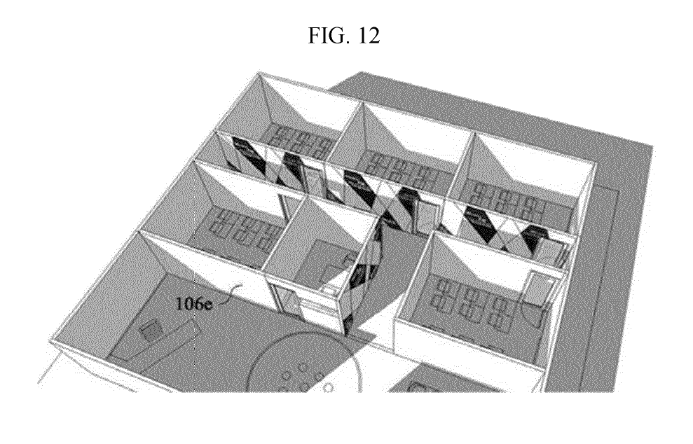

A final virtual space design 108 in which a partition wall of “∥ type” partition wall 106e is placed is shown in FIG. 12.

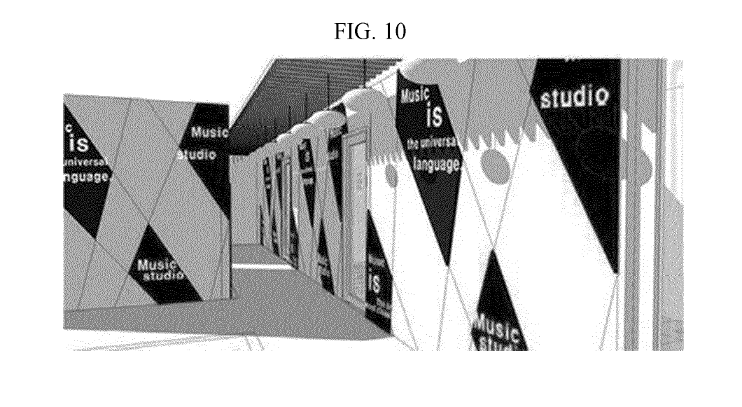

The interior design server 110 may provide the virtual space design where the partition walls are placed in a form of 3D image as shown in FIGS. 10 to 12.

When the virtual space design is generated, the interior design server 110 may provide a figure of a corridor formed by the partition walls in a 3D manner as shown in FIG. 10 by using the generated virtual space design. Such a 3D image may be provided in various view positions according to a selection of the user.

For example, when the user requests for an X position view of the virtual space design 108 shown in FIG. 8, the interior design server 110 may provide a 3D view at an X position as shown in FIG. 10.

In addition, when the user requests for a Y position view of the virtual space design 108 shown in FIG. 8, the interior design server 110 may provide a 3D view at a Y position as shown in FIG. 10.

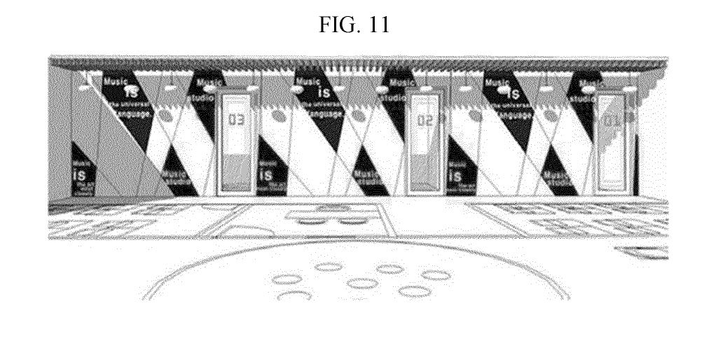

In addition, images shown in FIGS. 10 and 11 may be provided before the virtual space design 108 is completed. In other words, a 3D image shown in FIG. 11 is a 3D image before the partition wall of “□ type” 106d and the partition wall of “∥ type” 106e are formed.

Accordingly, the user may be provided with images identical to directly checking with his or her own eyes in the real space, and may directly perform designing as he or she wants.

Meanwhile, the partition walls 106a to 106e may be provided in a form as shown in FIG. 9. In a virtual partition wall shown in FIG. 9, a door is installed, but a partition wall without a door may be provided. In addition, the partition wall may be provided in a form identical to the partition wall installed in the real space.

In other words, the interior design server 110 provides a virtual space design by using a virtual partition wall having a form identical to the partition wall applied to the real interior design construction, and thus the form of the virtual space design and the form of the real interior space that will be finally completed by interior design construction become the same.

5. Ordering Partition Wall

When the virtual space design shown in FIG. 8, and FIGS. 10 to 12 is completed, the user places an order for the partition walls to the interior design server 110 by using the user terminal 100.

Herein, the interior design server 110 may transmit to the user terminal 100 a cost for fabricating the partition walls by using the 3D printer, a cost for installing the partition walls, and a construction period for installing the partition walls. Accordingly, the user may place an order for the partition walls after checking the above information.

Meanwhile, when performing interior design construction for installing the partition walls in the interior space, in addition to installation of the partition walls, various interior decorations, for example, finishing material of the partition walls, and additional interior design parts such as lamp as shown in FIGS. 10 and 11 may be required. Accordingly, the user may select parts required in addition to the partition walls, according to a menu provided by the interior design server 110.

6. Generating 3D Printing Information

When an order for the partition walls which requests installation the partition walls corresponding to the virtual partition walls in the real space by using the virtual space design is received from the user terminal 100, the interior design server 110 transforms the partition walls according to the order to 3D printing information so as to be fabricated by using the 3D printer, and transmits the same to the 3D product output center 130.

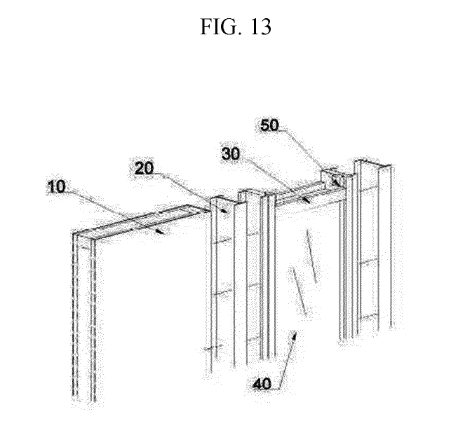

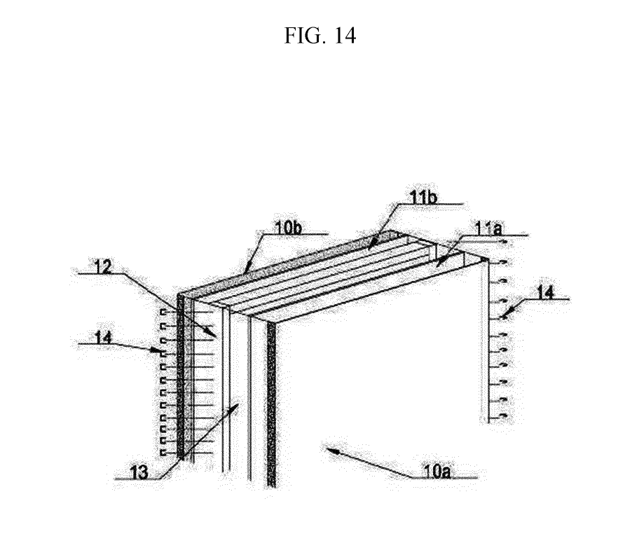

FIG. 13 is a view of an assembling example of the partition wall. FIG. 14 is a deployed view of the partition wall.

As shown in the figure, the partition wall may include a panel 10, an H-bar 20, a glass partition 30, a glass 40, an upper finishing frame 50, surface fabrics 10a and 10b, gypsum boards 11a and 11b, a sheet material 12, a sound-absorbing thermal insulating material 13, and fabric fixing brad nails 14.

In order to fabricate the above partition wall by using the 3D printer, thickness has to be assigned to 3D images of partition walls that are generated by the interior design server 110. This is because, as described above, the practical partition walls have thickness, but the 3D image formed by the interior design server 110 does not include thickness information.

Accordingly, the interior design server 110 generates thickness information for assigning thickness to each partition wall by using the data transform unit 115.

In addition, as described above, the panel 10 may be filled with the sound-absorbing thermal insulating material 13, and for the same, internal structure information is added.

In addition, as described above, materials of the panel 10, the H-bar 20, the glass partition 30, the glass 40, the upper finishing frame 50, the surface fabrics 10a and 10b, the gypsum boards 11a and 11b, the sheet material 12, the sound-absorbing thermal insulating material 13, and the fabric fixing brad nails are different.

Accordingly, for the same, the interior design server 110 defines the material for each component.

As above, the interior design server 110 generates thickness information that assigns thickness to the 3D image information, generates internal information of the interior of the partition wall, and generates material information of each component, and transmits the same to the 3D product output center 130 by using the transmitting unit 116.

7. Fabrication and Delivery of Each Partition Wall

In the 3D product output center 120, the partition walls are fabricated by using the 3D printer, and a delivery request thereof is transmitted to the delivery center 130.

In addition, the delivery center 130 delivers the fabricated partition walls to the user according to a delivery request, and uploads a delivery state to a delivery server so that the user may identify the delivery state.

8. Performing Construction

A period for interior design construction is finally determined as information of the fabrication period of the partition walls, and construction start and end dates, etc. is transmitted to the user terminal 100 through a communication method such as phone call or e-mail according to the user places an order of the partition walls.

Accordingly, the constructor fabricates the partition walls and performs interior design construction of placing the partition walls in the real space.

According to the present invention described above, recently, fabricating various products using 3D printing is attracting much attention, and by using the same, satisfying user need and saving time and money is possible.

A skilled person in the art to which the present invention pertains will be able to understand that the present invention may be embodied in other specific forms without modifying the technical concepts or essential characteristics of the present invention. In this regard, the exemplary embodiments disclosed herein are only for illustrative purposes and should not be construed as limiting the scope of the present invention. On the contrary, the present invention is intended to cover not only the exemplary embodiments but also various alternatives, modifications, equivalents, and other embodiments that may be included within the spirit and scope of the present invention as defined by the appended claims.

What is claimed is:

1. A system for fabricating an interior design product by using a 3D printer, the system comprising:
an interior design server providing a list of interior design products to a user terminal accessed thereto, when the user selects a specific interior design product, providing a simulation enabling a user to place the selected interior design product in a virtual space, and when the user selects the interior design product having a desired design and requests an order for the same, generating and outputting 3D printing information of the interior design product having the corresponding design; and
a 3D product output center receiving the 3D printing information generated in the interior design server and fabricating the interior design product by using a 3D printer, wherein
when the selected interior design product is a partition wall, the interior design server:
receives from the user terminal real space information that includes a building name, an address, an area, horizontal and vertical lengths, a number of current lights, an intensity of illumination, an installation position, and generates a virtual space in association with the received real space information;
receives from the user terminal information required for dividing the generated virtual space into a plurality of spaces which includes a partition wall form, a size, whether or not to install a door, a number of persons to be accommodated in the virtual space, a number of rooms, a required intensity of illumination, and a movement path, and generates a floor plan for dividing the virtual space into the plurality of spaces in association with the received information; and
selects a partition wall for dividing the virtual space into the plurality of spaces according to the generated floor plan by receiving partition wall information from the user terminal, and dividing the virtual space into the plurality of spaces by using the selected partition wall and displaying the same in a 3D manner, and
wherein the 3D printing information includes 3D image information of the partition wall, thickness information of the partition wall, internal structure information of the partition wall, and material information of the partition wall.

2. The system of claim 1, further comprising a delivery center performing delivery to the user according to a delivery request, and uploading a delivery state to a delivery server so that the user identifies the delivery state, and
when the fabrication of the interior design product is completed, the 3D product output center transmits the delivery request to the delivery center.

3. The system of claim 1, wherein the interior design server includes:
an interface performing communication with the user terminal through a network;
an input unit for receiving various selection signals from the user;
a product providing unit providing the list of the interior design products to the user terminal, and enabling the user to select the interior design product by using the user terminal;
a simulation providing unit requesting and receiving information required for generating the virtual space in which the real space is reflected from the user through the user terminal, providing the simulation enabling the user to place the selected interior design product by providing the virtual space in which the real space is reflected in association with the received information, and enabling the user to finally select the desired products by selecting a desired form and color through the simulation;
a data transform unit generating 3D image information including the thickness information, the internal structure information, and the material information such that the interior design products according to the order are fabricated by using the 3D printer; and
a transmitting unit transmitting the 3D printing information to the 3D product output center.

4. A method of fabricating an interior design product by using a 3D printer, the method comprising:
step (A) of providing, by an interior design server, a list of interior design products to a user terminal accessing the server and when a specific interior design product is selected, providing a simulation enabling a user to place the selected interior design product in a virtual space;
step (B) of generating, by the interior design server, 3D printing information of the interior design product having a corresponding design when the user select the interior design product having a desired design and places an order thereof, and transmitting the same to the 3D product output center; and
step (C) of receiving, by the 3D product output center, the 3D printing information generated in the interior design server, and fabricating the interior design product by using a 3D printer, wherein the step (A) includes:
step (A-1) of accessing, by the user, the interior design server through the user terminal;
step (A-2) of providing, by the interior design server, the list of the interior design product to the user terminal;
step (A-3) of selecting, by the user, the desired product from the provided list of the interior design products by using the user terminal; and
step (A-4) of providing, by the interior design server, the simulation enabling the user to place the selected interior design product by providing the virtual space in which a real space is reflected,
wherein the step (A-4) includes:
when the selected interior design product is a partition wall, transmitting, by the user terminal, real space information including a building name, an address, an area, horizontal and vertical lengths, a number of current lights, an intensity of illumination, an installation position to the interior design server;
generating, by the interior design server, the virtual space in association with the real space information received from the user terminal;
transmitting, by the user terminal, information required for dividing the generated virtual space into a plurality of spaces which includes a partition wall form, a size, whether or not to install a door, a number of persons to be accommodated in the virtual space, a number of rooms, a required intensity of illumination, and a movement path to the interior design server;
generating, by the interior design server, a floor plan for dividing the virtual space into the plurality of spaces in association with the received information;
selecting, by the interior design server, the partition wall for dividing the virtual space into the plurality of spaces according to the generated floor plan based on partition wall information transmitted from the user terminal; and
dividing, by the interior design server, the virtual space into the plurality of spaces by using the selected partition wall, and displaying the same in a 3D manner,
wherein the 3D printing information includes 3D image information of the partition wall, thickness information of the partition wall, internal structure information of the partition wall, and material information of the partition wall.

5. The method of claim 4, further comprising:
step (D) of transmitting, by the 3D product output center, a delivery request to a delivery center when fabrication of the interior design product is completed; and
step (E) of performing delivery, by the delivery center, to the user according to the delivery request, and uploading a delivery state to a delivery server such that the user identifies the delivery state.
